(19) United States
(12) Patent Application Publication
(10) Pub. No.: US 2007/0300033 A1
(43) Pub. Date: Dec. 27, 2007

(54) System and method for reconfiguring continuous data protection system upon volume size change

(75) Inventor: Yoshiki Kano, Sunnyvale, CA (US)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/473,195

(22) Filed: Jun. 21, 2006

(51) Int. Cl. G06F 12/00

(52) U.S. Cl. 711/170

(57) ABSTRACT

Method and system for changing size of volumes in a CDP environment. The administrator can reduce the amount of work necessary to change the size of the primary volume protected by a CDP system. The system operates in conjunction with all three implementations of the CDP, including the After-Journal(JNL), After-Journal with snapshot and Before-Journal. In the After-JNL implementation, the CDP manager writes the journal data to the JNL volume, which corresponds to the changes in the primary volume occurring after a point in time copy of the primary volume has been created in the base volume. Upon the change of the primary volume size, the CDP automatically reconfigures the related volumes used by the CDP. According to one method, CDP records a size event into the journal and uses this size event to reconfigure the related volumes. In accordance with another method, the CDP reconfigures the related volumes based on the primary volume size.

### FIELD OF THE INVENTION

This invention generally relates to data storage systems and, more specifically, to continuous data protection systems.

### DESCRIPTION OF THE RELATED ART

Continuous Data Protection (CDP) technology provides a continuous protection for user data by journaling every write input-output (IO) operation performed by a user application. The journaling log is stored on a storage device, which is independent from the primary system storage. The modern CDP systems detect various activities of the target software application, such as timing checkpoint in events or the installation of the application. The CDP systems then store information on the activities of the target, writing the marker information in the header of the respective log records.

An exemplary storage based CDP system is described in a published U.S. Patent Application No. US20040268067 A1, titled “Method and apparatus for backup and recovery system using storage based journaling as a reference,” which is incorporated herein by reference. The described system provides copy on write journaling capabilities and keeps unique sequence number for journal log and snapshot images of application data.

In addition, there are-several available commercial CDP products. One major enterprise product is REVIVO CPS 1200i. The description of this product can be found at http://www.revivio.com/index.asp?p=prod_CPS_{—}1200i, and is incorporated herein by reference. The aforesaid product operates to mirror input-output (IO) operations performed by a host system. The data mirroring is performed by an appliance, which receives mirrored IO data and stores the received data in the journal format, additionally providing indexing information for subsequent restore operation.

Another CDP product, which is capable of studying the behavior of a software application, is XOSoft's Enterprise Rewinder User Guide product, a description of which may be downloaded from http://www.xosoft.com/documentation/EnterpriseRewinder_User_Guide.pdf and is incorporated by reference herein. This product, designed specifically for Microsoft® Exchange®), adjusts its own operation based on the behavior of the user application.

In a conventional CDP system, then the administrator needed to change the size of the primary volume protected by the CDP, he or she had to manually reconfigure all the related storage volumes necessary for the CDP operation. This required substantial time expenditure. Therefore, a new technology is desirable that would provide for automatic reconfiguration of the CDP system upon the change in the size of the primary volume.

### SUMMARY OF THE INVENTION

The inventive methodology is directed to methods and systems that substantially obviate one or more of the above and other problems associated with conventional techniques for continuous data protection.

In accordance with one aspect of the inventive concept, there is provided a method involving receiving a volume size change request for a target volume protected by a continuous data protection system; suspending input-output operations between a host and the target volume; changing the capacity of the target volume; writing a new size event corresponding to the target volume to a cache memory or to a journal, the new size event comprising information on the target volume capacity change; and resuming processing of input-output operations between the host and the target volume.

In accordance with another aspect of the inventive concept, there is provided a method involving determining whether a used portion of a journal volume of a continuous data protection system exceeds a high watermark; if the used portion is determined not to have exceeded the high watermark, awaiting a predetermined time interval and repeating the previous step; if the used portion is determined to have exceeded the high watermark, checking a portion of the journal volume of the continuous data protection system for a size event; if a size event is found, allocating a free logical device of the same size as a size specified in the latest found size event; and applying data from the journal volume to a baseline volume and writing the resulting data to the allocated logical device.

In accordance with yet another aspect of the inventive concept, there is provided a method for creating a restore image in a continuous data protection system. The inventive method involves allocating a target volume in the continuous data protection system from a pool of available logical devices; creating a point-in-time copy of data in the target volume and storing a journal sequence number corresponding to the created point-in-time copy; determining whether the journal contains a size change event; if the size change event is found, allocating or de-allocating at least one logical storage device to the target volume; applying a portion of the journal data to the target volume; and storing the latest journal sequence number after applying the journal data.

In accordance with yet another aspect of the inventive concept, there is provided a method involving receiving a volume size change request for a target volume protected by a continuous data protection system; suspending input-output operations between a host and the target volume; changing the capacity of the target volume and a baseline volume of the continuous data protection system; and resuming processing of input-output operations between the host and the target volume.

In accordance with yet another aspect of the inventive concept, there is provided a method involving allocating a restore volume from a pool of logical devices based on volume size on volume size events or referable volume size information on cache; creating a point in time copy of data in the primary volume and writing the created copy to the allocated restore volume; applying journal data to the allocated restore volume, the applied journal data starting from a first sequence number corresponding to the created point in time copy and continuing until a second sequence number specified by a user; and storing a third sequence number corresponding to the last applied journal data.

In accordance with further aspect of the inventive concept, there is provided a computerized system for continuous data protection. The inventive system includes a target volume; a journal volume; a console operable to receive a volume size change request for a target volume and a controller. The controller is configured to suspend, in response to the received size change request, input-output operations between a host and the target volume; change the capacity of the target volume; write a new size event corresponding to the target volume to a cache memory or to a journal, the new size event comprising information on the target volume capacity change; and resume processing of input-output operations between the host and the target volume.

In accordance with yet further aspect of the inventive concept, there is provided a computerized system for continuous data protection. The inventive system includes a primary volume storing user application data; a baseline volume storing a point in time copy of data in the primary volume; a journal volume storing primary volume data change information; a storage device storing a high watermark value and a low watermark value; and a journal manager. A journal applying process on journal manager is configured to determine whether a used portion of the journal volume exceeds the high watermark value. If the used portion is determined not to have exceeded the high watermark value, the journal applying process on the journal manager is configured to await a predetermined time interval and repeat the previous operation. If the used portion is determined to have exceeded the high watermark value, the journal applying process on the journal manager checks a portion of the journal volume for a size event. If a size event is found, the journal applying process on the journal manager is configured to allocate a free logical device of the same size as a size specified in the latest found size event; and apply data from the journal volume to the baseline volume and write the resulting data to the allocated logical device.

In accordance with yet further aspect of the inventive concept, there is provided a computerized system for continuous data protection. The inventive system includes a pool of available logical devices; a journal volume and a controller. The controller is configured to allocate a target volume from the pool of available logical devices; create a point-in-time copy of data in the target volume and store a journal sequence number corresponding to the created point-in-time copy; and determine whether the journal volume contains a size change event. If the size change event is found, the controller allocates or de-allocates at least one logical storage device to the target volume. The controller is further configured to apply a portion of the journal data to the target volume and store the latest journal sequence number after applying the journal data.

In accordance with yet further aspect of the inventive concept, there is provided a computerized system for continuous data protection. The inventive system includes a target volume protected by a continuous data protection system; a baseline volume storing a point in time copy of data in the target volume; a console operable to receive a volume size change request for the target volume; and a controller. The controller is configured to suspend input-output operations between a host and the target volume; change the capacity of the target volume and the baseline volume; and resume processing of input-output operations between the host and the target volume.

In accordance with yet further aspect of the inventive concept, there is provided a computerized system for continuous data protection. The inventive system includes a pool of available logical devices; a primary volume; a journal volume; and a controller. The controller is configured to allocate a restore volume from the pool of available logical devices; create a point in time copy of data in the primary volume and write the created point in time copy to the allocated restore volume; apply data stored in the journal volume to the allocated restore volume. The applied journal data starts from a first sequence number corresponding to the created point in time copy and continues until a second sequence number specified by a user. The controller is further configured to store a third sequence number corresponding to the last applied journal data.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary physical configuration of the inventive CDP system.

FIG. 2 illustrates an exemplary logical configuration of the inventive CDP system.

FIG. 3 shows an exemplary logical device manager table.

FIG. 4 shows an exemplary embodiment of expanded volume table.

FIG. 5 shows an exemplary embodiment of a logical unit (LU) to logical device (LDEV) mapping table.

FIG. 6 shows an exemplary embodiment of a CDP configuration.

FIG. 7 shows an exemplary embodiment of a table containing information on an LDEV pool.

FIG. 8 shows an exemplary embodiment of a table storing information within a free LDEV pool.

FIG. 9 shows an exemplary operating sequence of After JNL CDP system.

FIG. 10 illustrates an exemplary procedure for handing of a SCSI write operation addressed to the target LDEV by a journal manager.

FIG. 11 provides an overview of operation of the snapshot-related aspects of an After-JNL CDP with snapshot mechanism.

FIG. 12 shows an exemplary embodiment of a snapshot table.

FIG. 13 provides a diagram illustrating a Before-JNL CDP mechanism.

FIG. 14 shows exemplary procedures for processing a SCSI IO command for a target LDEV in accordance with a Before-JNL CDP configuration.

FIG. 15 shows an exemplary embodiment of the GUI.

FIG. 16 shows exemplary schematic sequences illustrating the operation of the inventive CDP system.

FIG. 17 shows an exemplary operating sequence of an After-JNL CDP system.

FIG. 18 illustrates an exemplary manner of creation of a restore volume.

FIG. 19 illustrates an exemplary operation of a Before-JNL CDP in relation to s size change operation on a primary volume.

FIG. 20 illustrates an exemplary operating sequence of an After-JNL CDP during a primary volume size change procedure.

FIG. 21 illustrates exemplary operating sequences of a second embodiment of an inventive CDP.

FIG. 22 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Initially, before the following detailed description, certain special terminology used within the aforesaid description will be explained. Specifically, as used herein, Logical Unit (LU) is a unit which is used to access data from host using SCSI command(s) on storage subsystem. The LU needs to be mapped to at least one logical device (LDEV). Logical Unit Number (LUN) is an identification number for each LU, which is used to specify the logical unit using SCSI command. Each LU has an associated set of World Wide Names (WWN) as well as LUN.

A Logical Device (LDEV) is a storage area configured to store data within a storage subsystem. It may consist of at least one physical disc. A Volume is a set of LDEVs. A volume may consist of a single LDEV or several LDEVs concatenated together. A restore volume is a set of LDEVs to which journal data has been applied in order to restore data at a certain point in time. A Virtual LU is an LU which is accessible from host regardless of the existence of LDEV on LU. Size event is an event relating to changing the storage volume capacity. Header/Footer information includes metadata for journal to keep data and marker, which is sent from host. Snapshot is a technology to create a point-in-time copy using copy-on-write technology. Snapshot volume is a volume to store old data when snapshot is used. Marker is sent from host's agent to storage subsystem. Finally, Header/Footer information may include metadata for journal provided to keep data and marker, which is sent from host.

### First Embodiment

### Overview

While the disclosure below describes two exemplary embodiments of the inventive concept, one or ordinary skill in the art would appreciate that the inventive technique may be applied to many types of CDP systems. In accordance with one of the features of the invention methodology, CDP records the volume size event. In accordance with another feature, the inventive CDP relies on the size of primary volume.

### First Embodiment

First embodiment illustrates a feature of the inventive methodology, wherein the CDP system records a volume size change event into the CDP journal. A characteristic of the first method for After-JNL and After-JNL with snapshot CDP implementations is that the JNL manager 24 extends or shrinks the baseline volume when the JNL manager 24 detects a size event in the portion of the JNL beginning with the oldest JNL record and ending with the record corresponding to the new baseline. One of the benefits of the aforesaid feature to the storage system administrator is that the administrator does not need to manually reconfigure other CDP volumes associated with the primary volume. Another characteristic of first embodiment applicable to all three CDP operating modes is that the CDP prepares the restore volume based on size event, which has been recorded in the JNL volume.

Physical Configuration

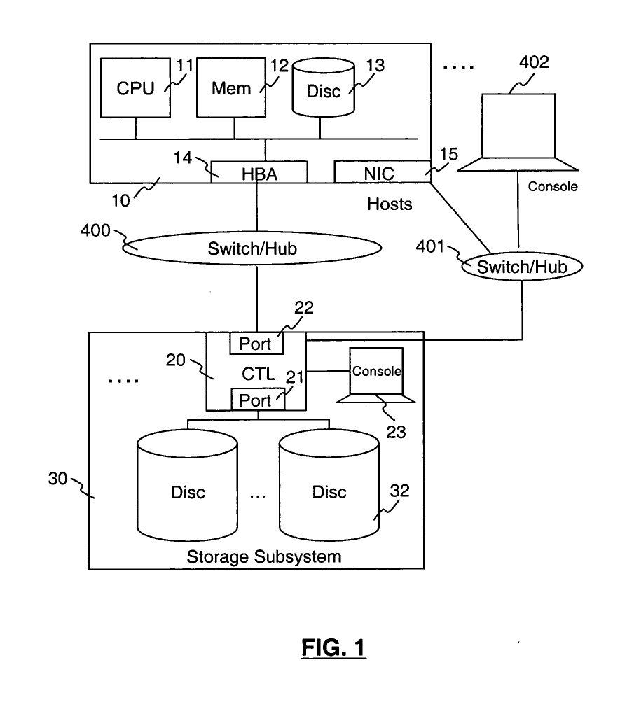

FIG. 1 depicts a schematic diagram illustrating the hardware components of the first embodiment of the inventive system as well as the interconnections among those hardware components. Specifically, the system in accordance with the first embodiment of the invention includes at least one host 10 coupled to at least one storage subsystem 30. The host 10 may execute under control of an operating system (not shown in FIG. 1) and may be implemented based on any suitable type of computer hardware platform, including a general-purpose workstation or a general purpose personal computer (PC). The host 10 may include a CPU 11, memory 12, and internal storage disc 13. The host 10 may additionally include a host bus adapter (HBA) 14 provided to enable a connection between the host 10 and fibre channel (FC) switch or Ethernet switch 400. As stated above, the system shown in FIG. 1 may include one or multiple hosts 10. Each such host 10 stores its data within a logical storage unit (LU) provided by storage subsystem 30.

In accordance with an embodiment of the invention, the storage subsystem 30 has the capability to accept commands formatted in accordance with SCSI-2 and/or SCSI-3 command sets and, responsive to the received commands, store the data on one or more LUs hosted by the storage subsystem 30. As would be appreciated by those of skill in the art, the storage subsystem 30 may include several RAID controllers (CTL) 20 and several storage disc drives 32. The aforesaid RAID controller 20 may include one or more processors, memory, network interface (NIC) such as Ethernet. Additionally or alternatively, the controller 20 may include one or more fibre channel (FC) ports configured to connect the controller 20 to storage area network (SAN) and/or to storage disk drives 32 of the storage subsystem 30. The controller 20 is operable to process various SCSI input/output (I/O) operations received from the host 10 and may implement various RAID levels and configurations using several storage disc drives 32 deployed with in the storage subsystem 30.

Preferably, the controller 20 includes a non-volatile random access memory (NVRAM) (not shown in FIG. 1). The NVRAM may be used as a caching device to temporarily store the data associated with I/O operations, and may provide the protection of the stored data in case of system power failure. In one embodiment of the invention, the NVRAM is implemented as a battery-powered a dynamic random access memory.

The controller 20 enables the storage subsystem 30 to be accessed through FC ports, which may be addressed by the host 10 using the WWN (World Wide Name) or any other appropriate addressing convention. As well known to persons of skill in the art, the WWN addresses specify the target ID, and consist of LUN associated with an FC port. The storage subsystem 30 may include a management console 29, which is connected to the storage subsystem 30 via an internal connection and is accessible from a shared console such as general-purpose PC or workstation having web access capability, which may be used to manage the storage subsystem 30. The console 29 is provided for use by the storage subsystem maintainer. The console 402 is provided to be used by storage administrator and may be located remotely with respect to the storage subsystem 30. The console 402 is accessible through the switch or hub 401, see FIG. 1.

Logical Configuration

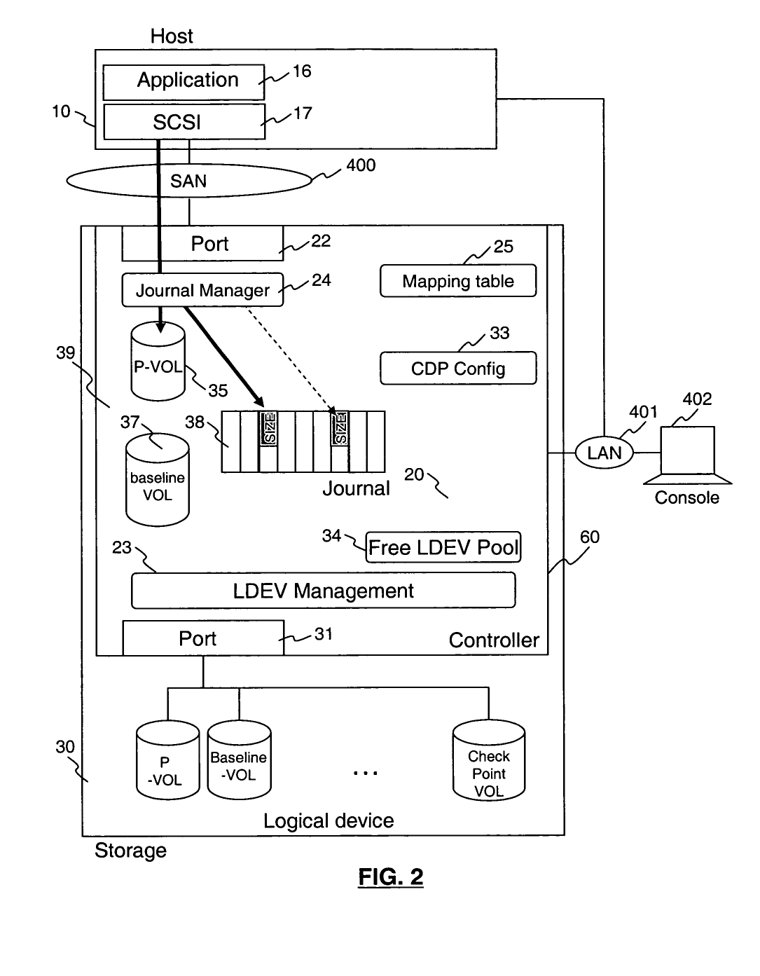

FIG. 2 shows a schematic diagram illustrating logical configuration of various software components of the inventive storage subsystem and the interconnections among those components.

SAN 400

SAN 400 provides a logical coupling between the host 10 and the storage subsystem 30. The SAN 10 may be implemented based on a switch or hub, operating in accordance with FC and/or Ethernet architectures. In one embodiment of the invention, the SAN is based on a fibre channel switch or hub. In another embodiment of the invention, the SAN is based on Ethernet switch or hub. As would be appreciated by those of skill in the art, the specifics of the design of the SAN 400 are not essential to the inventive concept and various other SAN architectures may be employed.

LAN/WAN 401

LAN/WAN 401 provides a logical connection between the aforesaid console 402 and the storage subsystem 30. The LAN/WAN 401 may be implemented using networking switches operating in accordance with Ethernet, FDDI, Token ring or other similar networking protocols. Also the network can run Internet protocol(IP) to communicate among machines. The storage subsystem 30 is connected to the LAN/WAN 401 in order to enable access thereto from other hosts, which may access the storage subsystem 30 for management as well as other purposes.

Host 10

As stated above, the host 10 may operate under control of an OS (not shown), application 16, which may include DB, and SCSI driver configured to enable access to Logical Units (LU) within the storage subsystem 30. The OS running on the host 10 may include, without limitation, UNIX, Windows, SOLARIS, Z/OS, AIX or the like. As would be appreciated by those of skill in the art, the exact type of the operating system executed by the host 10 is not essential to the inventive concept and many different types of operating systems may be utilized for this purpose. The application 16 may be a transaction-type application including a database (DB) or other similar types of business applications.

Storage Subsystem 30

In one embodiment of the invention, the modules of storage subsystem 30 shown in FIG. 2 are implemented using microcode, which is executed on the controller 20 (CTL). The aforesaid microcode may be provided in a form of a program code, which may be installed form an optical media, floppy drive (FD), flash memory, as well as other removal devices. The microcode may include a parity group manager (not shown), logical device manager (LDEV Manager) 23, which creates one or more logical devices (LDEV). The created logical devices group the physical discs 32 into volumes accessible to host 10 and Journal (JNL) Manager 24. The detailed description of the volumes organization will be provided below. A volume may be composed of a set of logical devices (LDEVs), wherein each LDEV can include a single LDEV or concatenated multiple LDEVs.

Parity Group Manager (not shown in FIG. 2)

This module may also be implemented using the aforesaid microcode and may provide a parity group functionality within the storage subsystem 30 using RAID0/1/2/3/4/5/6 technology, well known to persons of ordinary skill in the art. As would be appreciated by an ordinary artisan, the aforesaid RAID 6 technology is based on the RAID 5 technology, but is characterized by a dual parity data protection for enhanced data redundancy.

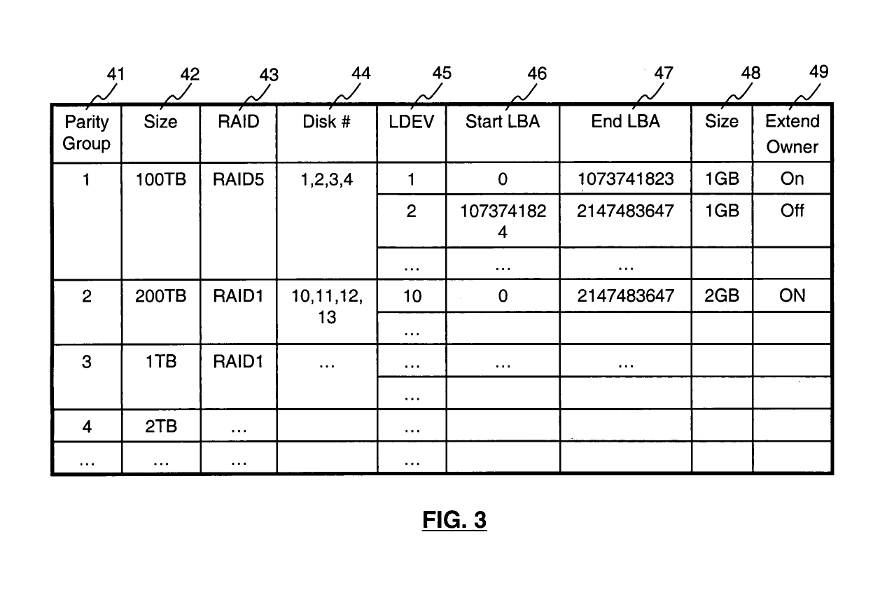

The various parity groups created by the aforesaid parity group manager may be listed in the LDEV Config table shown in FIG. 3. Each such parity group may have an associated parity group number 41, which identifies the parity group within the storage subsystem 30, information on usable storage capacity 42, which is created from the storage disks 32 using the aforesaid RAID technology, RAID configuration 43, as well as the information identifying the individual disk drives 44, which form each listed parity group.

LDEV Manager 23

The LDEV manager 23 manages the configuration of LDEVs within the storage subsystem 30. It also controls the 10 operations associated with the LUs of the storage subsystem 30. The LDEV manager 23 presents a set of multiple LDEV as a single LU volume to the host 10 and manages the data read and write operations initiated by the host 10. Each LDEV constitutes a portion of a respective parity group. The storage subsystem administrator defines the LDEVs within the storage subsystem 30 and performs initial formatting of a region of the LDEV adding the LDEV number information. The mapping between various LDEVs and the associated parity group is stored in the LDEV Config table shown in FIG. 3. For each parity group number 41, the aforesaid LDEV Config table stores the corresponding LDEV number information 45, which identifies the appropriate logical devices (LDEVs) within the storage subsystem. The aforesaid parity group record further contains the start logical block address (LBA) 46, which represents the LDEV's start address within the parity group as well as the end LBA address 47, representing the end address of the corresponding LDEV. In addition, the size record 48 provides information on the size of the LDEV, while flag 49 indicates whether the specific LDEV is a volume owner in a situation when there are several LDEVs and the LDEV Manager changes the number of LDEVs. Upon allocation, the LDEVs may be initially formatted at the requested issued by an administrator. By default, the LDEVs are formatted with “0” data. However, the initial LDEV format data can be changed by administrator, for example to “NULL” or any other character, via console 402.

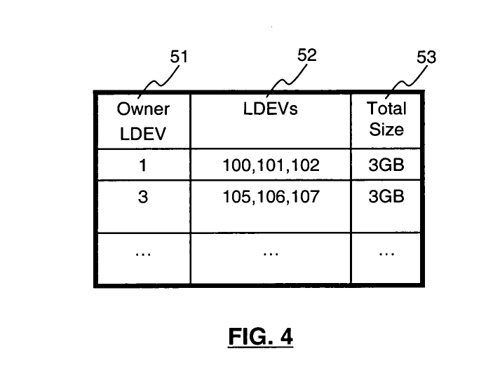

As has been described hereinbefore, the LDEV manager 23 manages the increase or decrease of the size of the volumes by allocating or de-allocating LDEVs to/from the target volume, as indicated by the owner LDEV flag 49. Specifically, to change the size of the volume, the LDEV manager 23 defines the owner LDEV in the column 49 of the table shown in FIG. 3 and assigns the LDEVs to the defined owner LDEV using a table shown in FIG. 4. The aforesaid table shown in FIG. 4 includes the owner LDEV column 51, which corresponds to the flag column 49 of the table in FIG. 3. The table depicted in FIG. 4 further includes LDEV number column 52, which associates the owner LDEV with other LDEVs listed in that column. Finally, the table of FIG. 4 includes the size column 53, which contains information on the total size of the owner LDEV after the completion of the change of size procedure.

The host 10 can retrieve the aforesaid size information contained in column 53 using a SCSI READ capacity command issued to the target LU. When the storage subsystem 30 receives this command, the storage subsystem 30 returns the total volume size 53, which includes the capacity of all LDEVs that are related to the owner LDEV.

Port 22

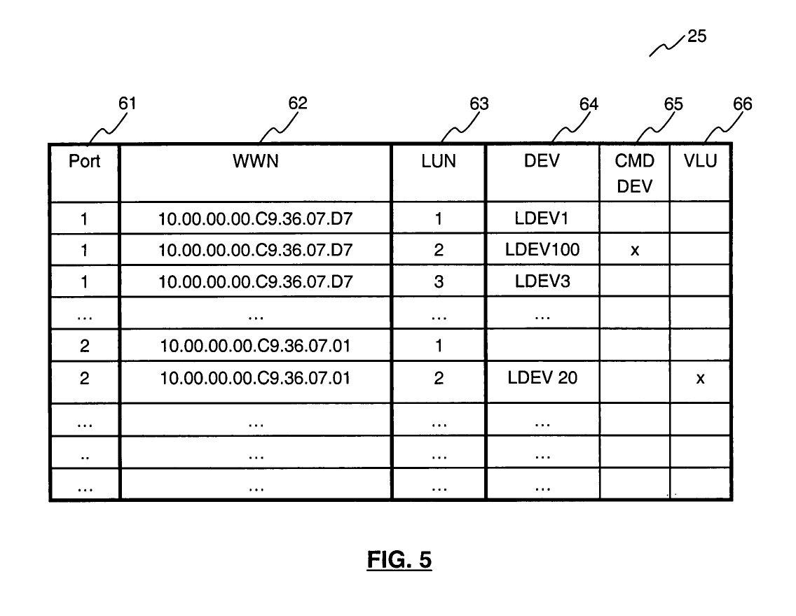

The port 22 provides access to the LDEVs via a logical unit (LU) associated with a WWN address accessible through the SAN 400. FIG. 5 shows an exemplary mapping table between the LUs and the LDEVs. Each value in the hardware port column 61 corresponds to one of the ports 22 in the architecture shown in FIG. 1. Each port 22 has its own WWN address 62. The WWN of the port 22 is assigned by the console 402. It should be noted that multiple LUs can be assigned to the same port 22. Each LU is specified by a WWN in column 62 and LUN in column 63. The maximum number of LUs which can be assigned to the same port is limited by the by 8 byte long LUN, in accordance with the fibre channel protocol (FCP) specification. Further, each LU is mapped to an LDEV, which stores the data from the host 10. Based on the aforesaid mapping, the controller 20 receives SCSI commands from the host 10 on its port 22 and converts the set of WWN 62 and LUN 63, specified by the commands, into the LDEV 64 in order to access the appropriate LDEVs.

In case of a SCSI command involving an extended LU, upon the receipt of the command, the controller 20 will first use the information in the table of FIG. 5 to determine the owner LDEV, which is identified in column 49 of the table shown in FIG. 3. Therefore, in the extended LU, the number of the mapped LDEVs in column 64 of the table in FIG. 5 is still one. However, one the owner LDEV is determined, the other accessible LDEVs, which are allocated to the owner LDEV, can be determined from the table in FIG. 4.

For each LU, the storage administrator may configure the LU as a virtual LU (VLU). A virtual LU appears as an LU to the host, even if it does not have any associated LDEVs. The virtual LUs may be used, for example, to create a restore volume. When the administrator configures an LU as a virtual LU, the controller turns on the VLU flag in column 66. If an LU is configured as a VLU, the storage subsystem 30 always makes it accessible to the host 10, regardless of whether an LDEV is assigned to the LU or not.

Virtual LU (not shown in the figures)

Initially, a virtual LU is not mapped to any volumes assigned to a port. The virtual LU in the storage subsystem 30 is assigned a logical unit number. The host 10 uses this logical unit number to address the VLU by including the logical unit number parameter within the SCSI command. Therefore, the host 10 can access the virtual LU by issuing a normal SCSI command. After receiving a SCSI inquiry directed to a virtual LU, the controller 20 of the storage subsystem 30 issues a normal response considering that the corresponding LDEV is unmapped. For example, if the SCSI size inquiry for LDEV is addressed to a virtual LU corresponding to an extended LDEV, the controller 20 returns the total size of all LDEVs (column 53), which correspond to the owner LDEV. If the target LDEV is not extended, the LDEV size in column 48 is returned. On the other hand, if the LU doesn't have any LDEVs and a SCSI Read/Write operation is directed to that Virtual LU, the controller 20 responds with an error message. If the LU doesn't have any LDEVs and a SCSI size inquiry is directed to that Virtual LU, the controller 20 responds with an error message or return size of zero.

When an administrator creates a virtual LU using a console, a journal (JNL) Manager 24 executing within the controller 20 marks the entry in the column 66 of the record in the table of FIG. 5, corresponding to the appropriate LUN on a port. When the administrator maps a restore volume, which is obtained by applying journal records to the LDEV, to a specific VLU, the port 22 is assigned to the LDEV specified in the column 64 of the corresponding record of the table 25 shown in FIG. 5. After that, the host 10 can access the LDEV through that VLU.

Finally, when an administrator un-maps a restore volume from the VLU, the assignment of the port 22 to the LDEV number listed in the column 64 for the VLU is removed. If a restore volume is mapped to a VLU, the size query to the VLU issued by the host 10 returns the size of the LDEVs mapped to the VLU. When a SCSI Read operation directed to the VLU is initiated by the host 10, the mapped restore volume is read.

Journal Manager 24

The journal manager 24 manages the journal of the CDP system and is configured to operate in three different modes, and, specifically, After-JNL, After-JNL with snapshot and Before-JNL. These operating modes of the journal manager 24 will be described in detail below. Before the following detailed discussion of the aforesaid JNL mechanisms, the volume configuration will be discussed.

Volume Configuration

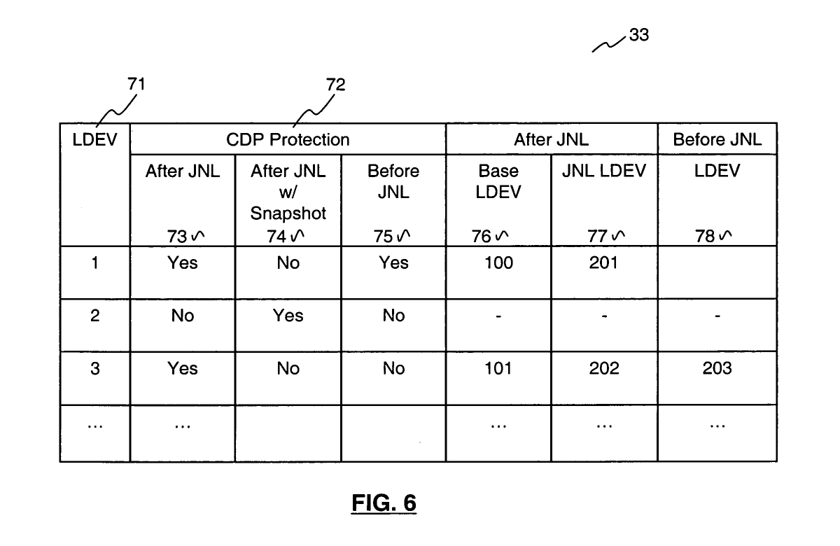

The mapping between the target primary volume (the volume which is being protected by the CDP) and the journal volumes provided in accordance with the After-JNL/Before-JNL mechanism is contained in the CDP Configuration 33 shown in FIG. 6. The CDP configuration table shown in FIG. 6 includes a target primary LDEV column 71 and the CDP protection mode columns 73 (After-JNL), 74(After-JNL with Snapshot) and 75(Before-JNL). The flags corresponding to After-JNL (column 73) and After-JNL with Snapshot (column 74) are mutually exclusive because the After-JNL mode provides the same CDP capabilities as the After-JNL with Snapshot mode, with the exception of the snapshot capability. If at least one of the protection modes 72 is enabled, the information on the volumes used by the CDP is stored in columns 76 to 78. In the CDP configuration with either After-JNL or After-JNL with snapshot mechanisms enabled, the baseline LDEV and JNL LDEV are specified in columns 76 and 77, respectively. In the CDP configuration with the Before-JNL mechanism enabled, the JNL LDEV is specified in column 78. The settings in columns 73 to 78 are created by the storage administrator via console 402.

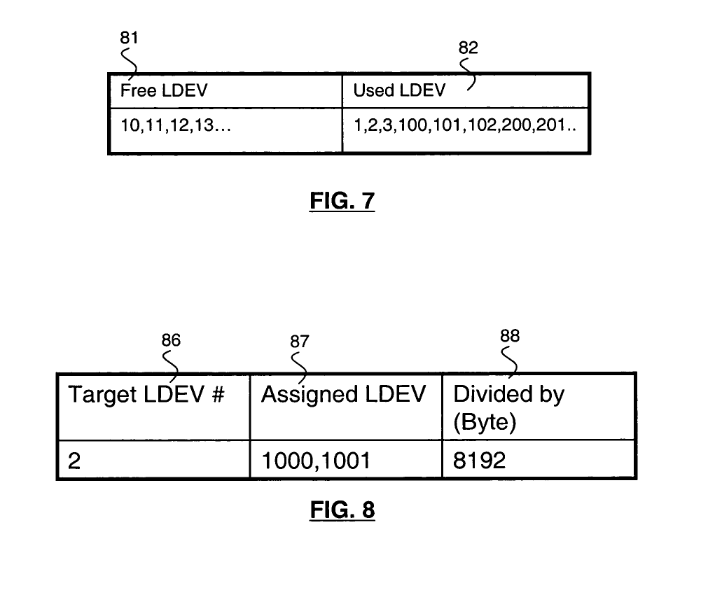

Upon the allocation of LDEVs, the LDEV manager takes a free LDEV from the free LDEV pool shown In FIG. 7. The free LDEVs are listed in the free LDEV field 81 of the table shown in FIG. 7. If an LDEV is allocated to a base LDEV or JNL LDEV, the LDEV is marked as “used” and is moved to the used LDEV field 82 in the LDEV pool shown in FIG. 7.

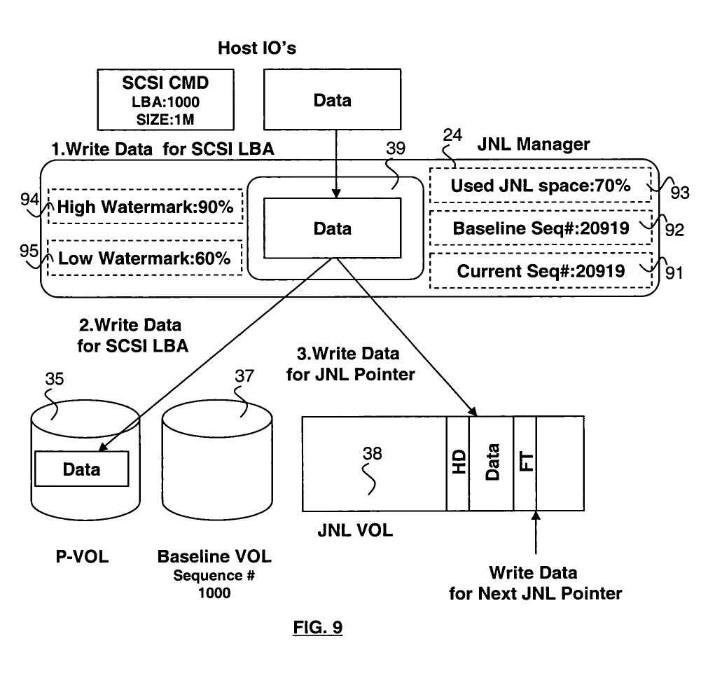

If the After-JNL with snapshot mode is enabled, the storage administrator assigns LDEVs to store the copy-on-write data associated with the snapshot mechanism. The table shown in FIG. 8 provides information on the free segment pool, which can be used for writing the snapshot. The table contains information on the target LDEV number associated with a snapshot (column 86) as well as information on the assigned LDEV numbers in the column 87, which form the free segment pool. The records in the column 88 define the size of the segment within the segment pool. In a snapshot, JNL Manager stores data in units equal to segments. If the target volume is modified, the JNL Manager 24 allocates a segment from the segment pool, reads the original target volume data from the corresponding baseline volume and stores the original data in the allocated segment.

With respect to the allocation of LDEVs for the CDP Protection modes in columns 72, controller may possess capability to automatically assign LDEVs from the free LDEV pool 81, see FIG. 7.

After-JNL Mechanism

FIG. 9 shows an exemplary diagram illustrating the After-JNL mechanism. Specifically, in accordance with the After-JNL mechanism, a history of all Write IO operations issued by the host 10 is created. In the After-JNL configuration, the CDP operates on a primary volume (P-VOL) 35, and allocates the baseline volume (baseline VOL) 37, and JNL volume (JNL VOL) 38. The primary volume is accessed by the host 10, which performs IO operations thereon. The baseline volume has a point in time copy of data in the primary volume. This copy is made at the time point when the journaling started on JNL volume 38. Each journal entry has a unique sequence number, which is incremented for each new journal operation. The initial sequence number is stored in the record 92 and represents the current sequence number at the time of creation of the aforesaid point in time copy. The JNL volume journals all IO operations affecting the primary volume. In addition, the JNL volume keeps the related CDP information, including the sequence number for each journal entry.

JNL manager keeps the JNL pointer 91, which indicates the current journal write position on JNL LDEV. The JNL pointer 91 starts from 0 and is tied to the appropriate logical block address (LBA). The JNL manager 24 continuously monitors the amount of the used JNL space to protect the JNL volume against overflow. The storage system administrator or the storage system vendor defines a high 94 and low 95 thresholds shown in FIG. 9. If the aforesaid thresholds are crossed, a de-stage operation is initiated on the JNL data. The de-stage operation applies the JNL data from the oldest journal record to the baseline volume 37 when the JNL manager 24 detects that the Used JNL space 93 exceeds the high threshold 94. In accordance with the inventive concept, the aforesaid thresholds are expressed as used percentages of the available space in JNL volume. In one embodiment of the invention, the default value for the high watermark is 80% and the default value for the low watermark is 60%. The JNL manager 24 periodically checks whether the percentage of the used JNL space 93 is over the high watermark 94. The storage administrator may change the threshold value and the frequency of the checking operation via the console 402.

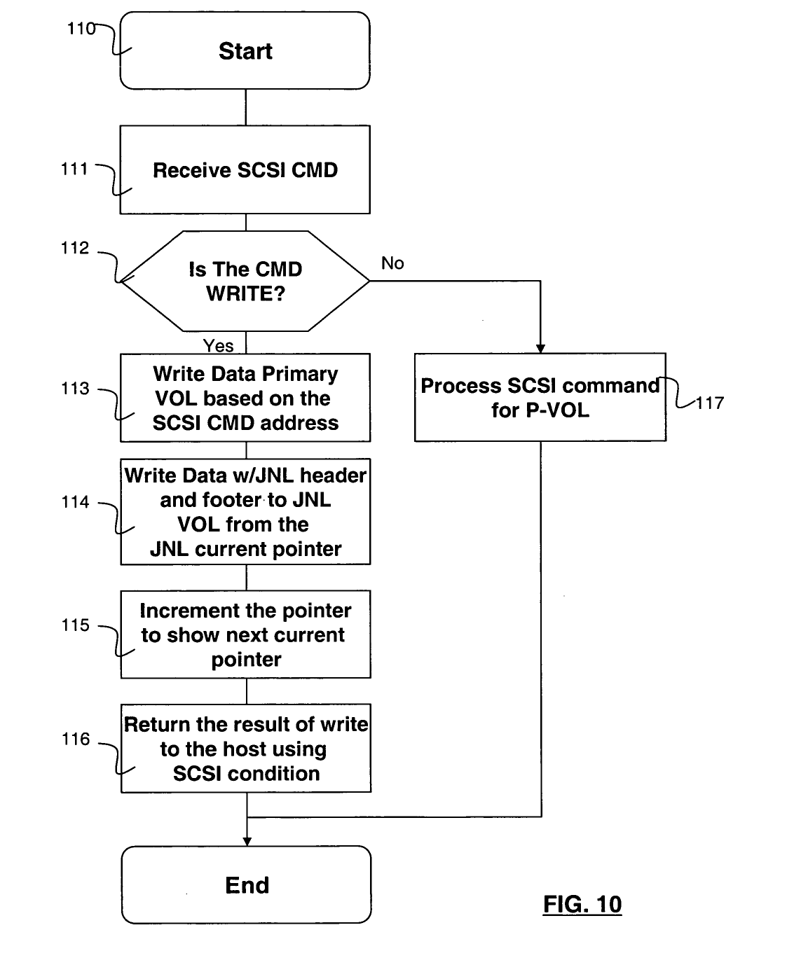

FIG. 10 illustrates the procedure for handing of a SCSI write operation addressed to the target LDEV by the JNL manager 24 shown in FIG. 9. The specific steps of the aforesaid procedure are described in detail below.

The procedure begins with step 111, whereupon the JNL manager 24 receives a SCSI command sent by the host 10. This step generally corresponds to the procedure 1 illustrated in FIG. 9.

At step 112, the JNL manager 24 checks whether the received command is a SCSI WRITE command, such as WRITE 6, WRITE 10, or the like. If the received command is a SCSI WRITE command, the procedure continues with Step 113. If the command is not a SCSI WRITE command, the procedure continues to Step 117.

At step 113, the JNL manager 24 writes the data, associated with the received SCSI command to the target primary volume 35. This step generally corresponds to the procedure 2 shown in FIG. 9.

At step 114, the JNL manager 24 writes header (HD) information, the received data and the footer (FT) information to the journal volume 38. The aforesaid write operation is performed starting from the JNL pointer's current LBA. This step generally corresponds to the procedure 3 of FIG. 9. The contents of the aforesaid header and footer written to the JNL volume will be described in detail below.

At step 115, the JNL manager 24 increases the value of the current JNL pointer 91 by the total size of the written header, data, and footer and calculates the used JNL space 93. The used JNL space portion 93 is calculated as a size of the used JNL volume divided by the total size of the JNL volume.

At step 116, the JNL manager 24 returns the result of the write operation to the originating host 10 using the SCSI state condition.

At step 117, the JNL manager 24 executes other SCSI commands, which do not involve modification of the data on the primary LDEV, which may include the READ 6 operation. Thereupon, the procedure terminates.

The header/footer information written to the JNL volume includes the header/footer bit as well as the journal entry sequence number 91, identifying the journaled IO operation within the CDP system. The header/footer further includes the command type indicating the type of header/footer record. The aforesaid command type may include journal data, marker or the like. The header/footer record may further indicate the time when the JNL manager 24 received the specific IO command, the type of SCSI command received from the host 10, the start address and the size for the journal data, as well as the header sequence number (in the footer only).

The current sequence number 91 is incremented by each header/footer insertion. If the sequence number reaches the maximum sequence number, it may restart from 0. In one embodiment of the invention, the size of the header/footer record is 2 KB, which is equivalent to the size of 4 logical blocks. As would be appreciated by those of skill in the art, the exact size of the header/footer is not essential to the inventive concept and other sizes may be used. For example, a larger header/footer size may be used to enable additional data to be written therein.

Upon the receipt of the restore instruction from the host 10 via the console 402, the storage subsystem 30 creates a restore volume corresponding to a point in time specified by a sequence number or time value. This is accomplished by applying the records in the JNL volume to the data in the base volume. Upon the creation of the restore volume, the JNL manager 24 maps it to a Virtual LU. Before the mapping operation, the JNL manager 24 checks whether the Virtual LU is mapped to another restore volume. If another restore volume has been mapped to the same virtual LU and the last Read/Write access thereto took place within the last minute, the old mapping is preserved and a new virtual LU is used for mapping to the first restore volume. If the virtual LU is unmapped or if the last access is old, the mapped restore volume is unmapped and the corresponding LDEV is returned to the free LDEV pool. The aforesaid restore procedure will be discussed in detail below.

After-JNL with Snapshot

In accordance with the After-JNL with snapshot CDP technique, an internal snapshot is created for a baseline volume using the copy-on-write technology, as in the After-JNL method. Using this snapshot, the JNL manager 24 is able to quickly restore an image of the base volume at a point in time specified by the administrator when the journal data applies to baseline each user or system defined term like 10 minutes or 20 minutes independently the de-stage operation using low-water mark and high-water mark, then and the snapshot is periodically taken on the term. The applied journal is remained. The applied journal is purged based on de-stage operation which was except the applying journal on baseline To create the restore image, the JNL manager applies all JNL records starting with the sequence number of the snapshot which is nearest last sequence number specified by user and ending with the sequence number corresponding to the point in time of the requested restore image.

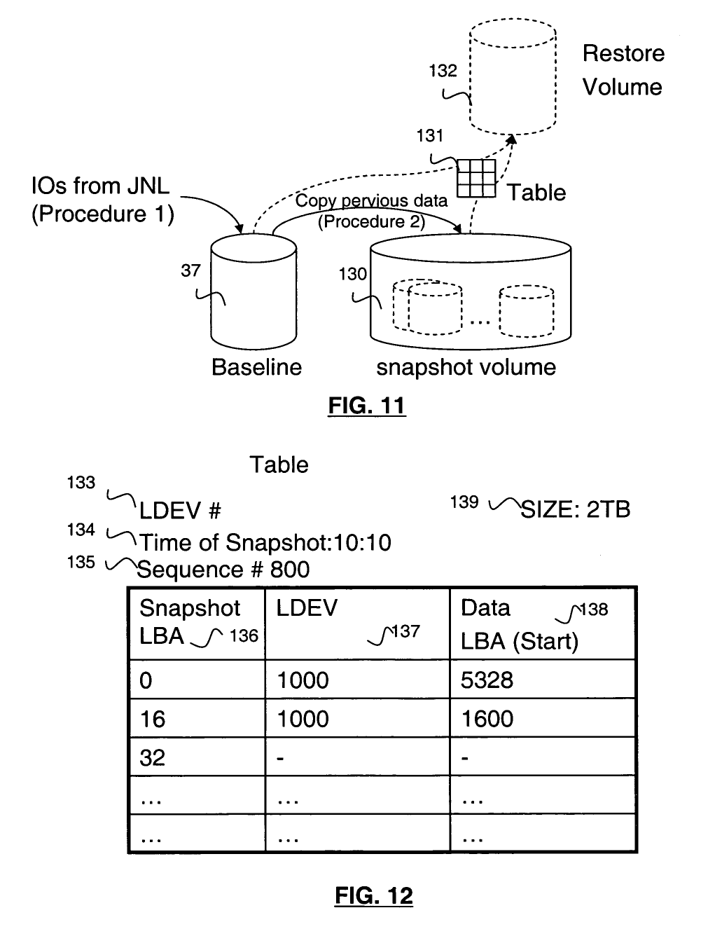

FIG. 11 provides an overview of operation of the snapshot-related aspects of the After-JNL with snapshot mechanism. The exemplary CDP system shown in FIG. 11 includes a baseline volume 37, a snapshot volume 130 and a restore volume 132. The journal manager 24 applies JNL data to the baseline volume, starting with a sequence number of the oldest JNL record and up to the latest sequence number of the JNL record by user or system defined period, see Procedure 1 in FIG. 11. The JNL manager 24 makes new snapshots periodically based on system or user-defined time intervals. In addition, the journal manager 24 independently purges portions of journal data between the high water mark and the low water mark. This procedure is performed when the value of the used JNL space in the record 93 in FIG. 9 exceeds the value of the high watermark. In one embodiment of the invention, the snapshots for a baseline volume are created on an hourly basis. One a snapshot is created, the JNL manager 24 allocates a snapshot table shown in FIG. 12 for each created snapshot. As stated hereinabove, because a snapshot uses the aforesaid copy-on-write technology, the previous baseline data is stored on the snapshot volume 130, as illustrated by the Procedure 2 of FIG. 11. The snapshot table shown in FIG. 12 includes the LDEV number 133, indicating the identity of the target LDEV, the time of snapshot record 134, indicating the time of the snapshot, as well as the snapshot sequence number record 135. In addition, the snapshot table includes the snapshot LBA column 136 storing the LBA of the restore volume, LDEV number column 137 identifying the LDEV storing the data, and the Data LBA (Start) column 138, indicating the start address of the data stored on the LDEV. The aforesaid restore operation will be discussed in detail below. In one implementation of the inventive system, the JNL manager maintains the JNL data in blocks having a predetermined fixed size, for example 8 KB or 16 KB.

Before-JNL Mechanism

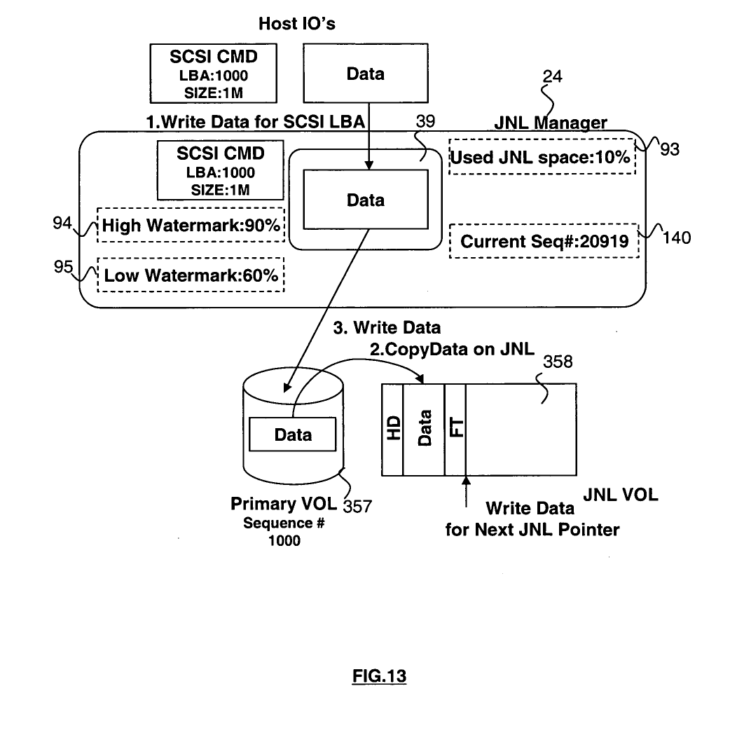

FIG. 13 provides a diagram illustrating the Before-JNL mechanism. The Before-JNL mechanism creates a journal-based history of the data in the primary volume. This CDP configuration uses only two volumes—the primary volume 357 and the JNL volume 358. The primary volume 357 is accessible by the host for IO operations. The JNL volume stores copy-on-write journal data for the primary volume as well as certain related CDP information, such as IO information. The JNL manager 24 keeps the current JNL pointer 140, which indicates the current write position on JNL volume. The Used JNL space record 93 as well as the low watermark record 95 and the high watermark record 94 for Before-JNL configuration are as same as those for the After-JNL configuration.

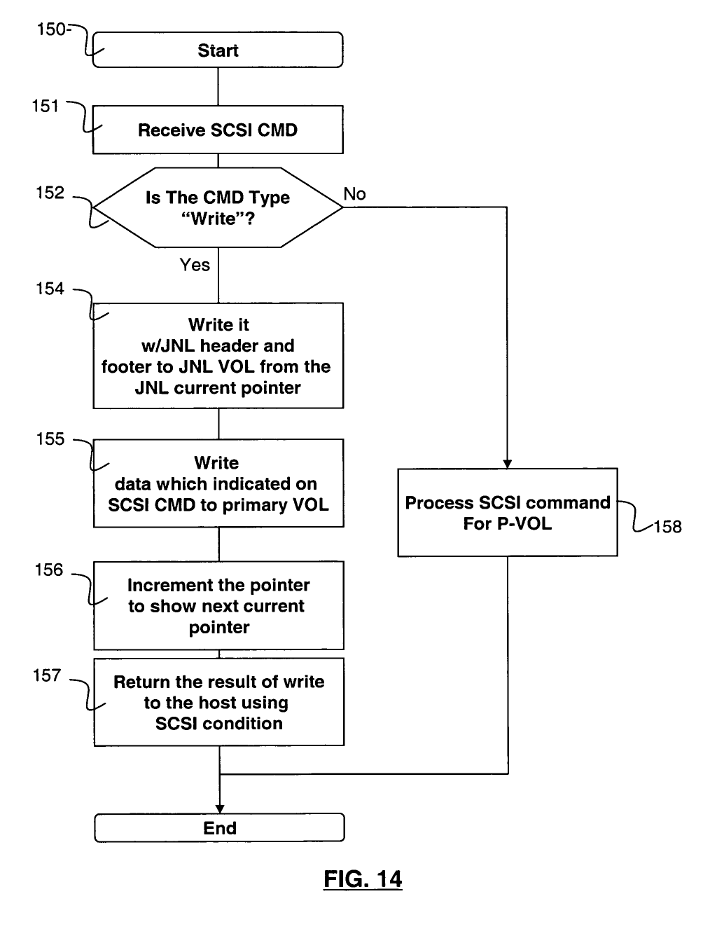

FIG. 14 shows exemplary procedures for processing a SCSI IO command for the target LDEV in accordance with the Before-JNL configuration illustrated in FIG. 13. The specific steps of the procedure are described in detail below.

The procedure begins with step 151, whereupon the JNL manager 24 receives a SCSI command, which is sent by the host 10. This step generally corresponds to the Procedure 1 illustrated in FIG. 13.

At step 152, the JNL manager checks whether the received command is a SCSI WRITE command, such as WRITE 6, WRITE 10, or the like. If the command is indeed the WRITE command, the procedure continues with the Step 154. If it is not, the procedure proceeds to the Step 158.

At step 154, the JNL manager 24 reads the old data which is identified by the LBA and the size parameter in the received WRITE operation. The old data corresponding to the new written data is read by the JNL manager 24 from the primary volume 357. After the completion of the read operation, the JNL manager 24 writes the header (HD) to the JNL volume 358. The header information will be described in detail below. Together with the header, the JNL manager writes the old data and the footer (FT) information to the JNL volume, starting from the current JNL Pointer's LBA, see Procedure 2 in FIG. 13.

At step 155, the JNL manager 24 writes the data contained in the received SCSI command to primary volume 357, see Procedure 3 in FIG. 13.

At step 156, the JNL manager 24 increments the current JNL pointer by the size of the header, data, and footer.

At step 157, the JNL manager 24 returns the result of the write operation to host 10, using the SCSI state condition.

At step 158, the JNL manager 24 executes other SCSI commands, which do not involve the data modification in the primary volume, such as READ 6 operation and the like. Whereupon, the procedure terminates.

During the restore operation, the storage subsystem 30 creates a restore volume specified by the time point only, or the time point and the sequence number. This information may be input via the console 402. The details of the restore procedure will be provided below.

Console 402

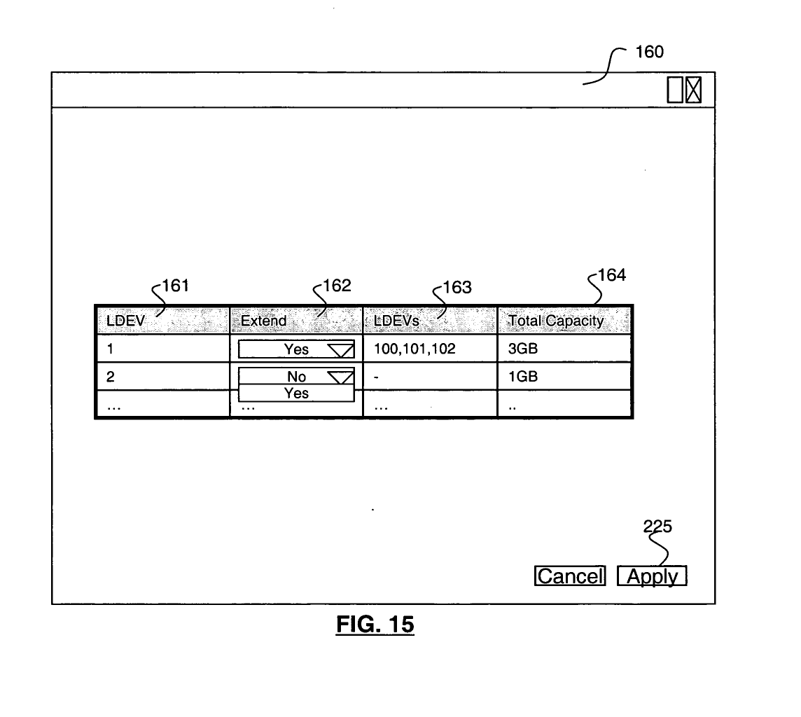

The console 402 enables the storage administrator to manage the storage subsystem 30 via LAN/WAN 401. The console 402 provides graphical user interfaces (GUIs) useful in the creation of LDEV, as well as tools for mapping of LDEVs to Logical Units (LUs) and the creation of LDEV pools. As would be appreciated by those of skill in the art, the console 402 is not limited to the described functionality and may perform other management functions. Specially, the console 402 may enable the administrator to shrink the size of the owner LDEV, which may be performed through the aforesaid GUI of the console 402. FIG. 15 shows an exemplary embodiment of the GUI.

The GUI displays the owner LDEV number 161, a pull down menu 162 giving an option to the administrator to define whether the owner LDEV is extended or not, specify LDEV numbers identifying all LDEVs allocated to the owner LDEV by selecting appropriate LDEVs from the free LDEV pool with reference to the size of LDEV, indicated by entry 48 shown in FIG. 3, and the total the capacity 164 of the extended owner LDEV. As stated above, the aforesaid extended capacity of the owner LDEV is the actual capacity of the owner LDEV plus the capacity of all LDEVs allocated to the owner LDEV. Any LDEV entry 163 may be deleted in order to shrink the size of the corresponding volume.

Method of Operation

The following description illustrates the operation of the system for After-JNL (Case 1), After-JNL with Snapshot (Case 2) and Before-JNL (Case 3) after an LDEV is expanded or shrunk during the normal operation or the restore operation.

Case1: After-JNL

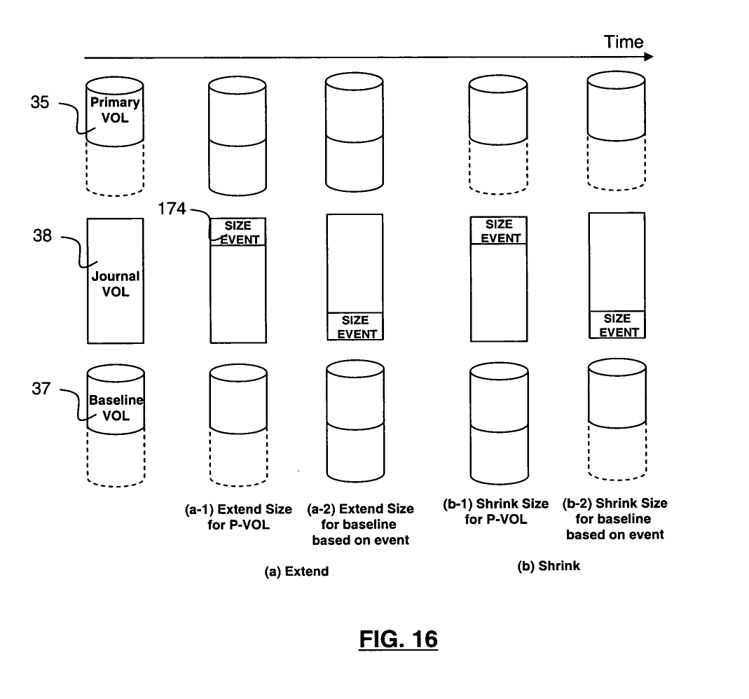

FIG. 16 illustrates exemplary schematic sequences representing situations when (1) the storage administrator changes sizes of specific volumes by adding or removing LDEVs; (2) the JNL manager 24 de-stages JNL data to baseline volume and (3) the storage administrator restores the restore volume my means of a virtual LU, upon the volume size change.

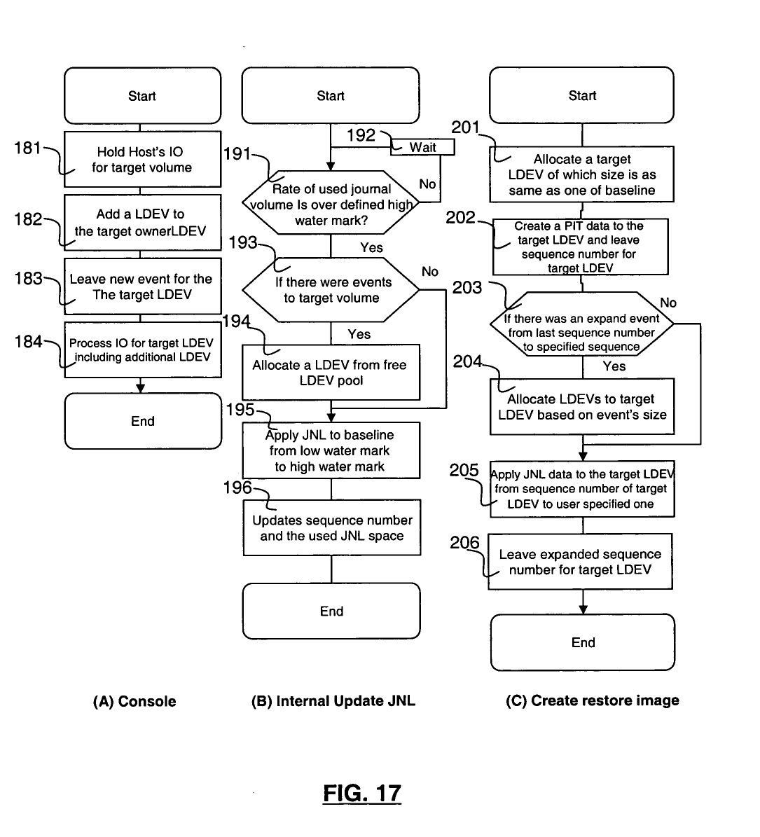

In the case of the volume size change, when the administrator expands (a-1 in FIG. 16) or shrinks the volume (b-1 in FIG. 16), the JNL manager 24 executes the procedure (A) shown in FIG. 17. The detailed description of this procedure is presented below.

At step 181, the JNL manager 24 holds the IO operations of the host 10 for the target volume.

At step 182, the JNL manager 24 adds an LDEV to the target owner LDEV, which may be specified by the storage administrator via the console 402.

At step 183, the JNL manager 24 writes information on the new size event corresponding to the target LDEV to the cache memory or the header and/or footer of the JNL.

At step 184, the JNL manager 24 continues to process IO operations of host 10, including the operations directed the new extended LDEV. Whereupon, the procedure terminates.

In case of updating the JNL data to the baseline, when the JNL manager 24 de-stages the JNL data on the JNL volume to the baseline volume, as shown in the FIG. 16a-2, the JNL manager 24 executes the procedure (B) shown in FIG. 17. The details of this procedure are described below.

At step 191, the JNL manager 24 checks whether the share of the used journal volume 93 exceeds the high watermark 94. If the high watermark is exceeded, the operating sequence proceeds to the step 193. If the used portion is below the high watermark, the process continues with the step 192.

At step 192, the JNL manager 24 awaits a predetermined time interval until the next check is performed. In one embodiment of the invention, the aforesaid time interval is equal to one hour.

At step 193, the JNL manager 24 checks the portion of the JNL for the size events associated with the target de-stage data. The checked portion of the JNL starts with the sequence number corresponding to the low watermark and continues to the current sequence number 140. If any size events are found, the operating procedure continues to step 194. If there are no size events, the procedure goes toe the Step 195.

At step 194, the JNL manager 24 selects a free LDEV of the same size as the size specified in the latest size event less the size of baseline, which indicates the size of the volume to be added.

At step 195, the JNL manager 24 applies the JNL data to the baseline. The applied JNL data starts from the current sequence number and continues to the sequence number corresponding to the low watermark.

At step 196, the JNL manager 24 updates the sequence number for the baseline volume and the information on the used JNL space, ignoring the de-staged data. Thereupon, the aforesaid procedure terminates.

As the result of the extend and restore operations, the JNL Manager changes the size of the baseline volume upon applying the JNL data, if a size event is detected during the de-stage procedure, see FIG. 16a-2, b-2.

In case of the data restore procedure, the storage administrator requests a point-in-time version of the primary volume. In response to the received restore command, the JNL manager 24 creates the restore image by applying journal records, selected based upon the specified sequence number or time to the baseline volume. The volume size change is handled during the restore procedure in the way described in detail below. Specifically, the respective procedure is shown in FIG. 17(c).

At step 201, the JNL manager 24 allocates a target volume from the free LDEV pool. Preferably, the size of allocated target LDEV is the same as the size of the baseline volume.

At step 202, the JNL manager 24 creates a point-in-time (PIT) version of the data in the target volume and notes the sequence number corresponding to the created point-in-time version.

At step 203, the JNL manager 24 checks whether the JNL contains an event indicating the expanded baseline LDEV. If such an event is found, the operating procedure continues to the step 204. If the event is not found, the procedure goes to Step 205.

At step 204, the JNL manager 24 allocates or de-allocates LDEVs from the LDEV pool to the target volume, such that the new size of the target volume equals to the size specified in the size event.

At step 205, the JNL manager 24 applies the JNL data to the target LDEV. The applied JNL data starts from the sequence number corresponding to the target LDEV and continues to the user specified sequence number. If the sequence number is specified by the user using the time, the JNL manager 24 picks up the sequence number from the point in the JNL, which corresponds to that specified time.

At step 206, the JNL manager stores the latest sequence number after applying the JNL data. Thereupon, the procedure terminates.

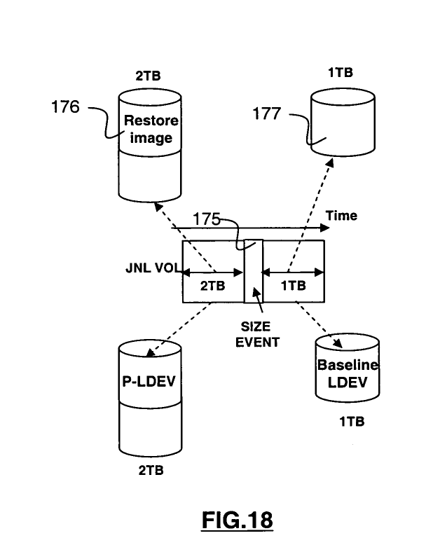

FIG. 18 illustrates the manner of creation of the restore volume. If the user specified sequence number is prior to size event (175), the JNL manager 24 provides the restore volume of the same size as the primary volume, see FIG. 18, 176. If the user specified sequence number is after the size event, the JNL manager 24 allocates or de-allocates LDEVs based on the latest size event before the user specified sequence number, see FIG. 18, 177. The JNL manager 24 may map the restore volume through the virtual LU by specifying the LDEV number column 64 in the table shown in FIG. 5.

Case 2: After-JNL with Snapshot

The operation for expanding the LDEV as well as the JNL update operation for the After-JNL with snapshot configuration are similar to the corresponding operations for the After-JNL configuration, which were described in detail above with reference to the Case 1. The primary difference between the corresponding operations is that in the After-JNL with snapshot mode, the size information for each snapshot of the baseline volume is saved into the memory each time the snapshot is taken. As it has been discussed hereinabove, the JNL manager applies journal records to the baseline volume periodically and independently from the de-stage operation. The baseline volume can be expand based on the size of marker in the JNL volume, which is specified via the console operation (A) shown in FIG. 17. The internal journal update operation involves periodic execution of steps 193 through 196, shown in FIG. 17. Specifically, when the JNL Manager periodically takes snapshots of the baseline volume, the JNL Manager saves the size information for each such taken snapshot, see element 139 in FIG. 12. The snapshot generation interval (such as hourly) may be specified by the user from the console 402.

When the volumes are shrunk pursuant to a command received via the console 402, the JNL Manager verifies that the size of the baseline volume does not drop below the size of the largest snapshot. This is done because each snapshot relies on the data stored in the baseline volume and the baseline volume is used in snapshot restore operation. If, during the shrinking operation, the JNL Manager de-allocated a specific LDEV, which stored data relied upon by one or more snapshots, the affected snapshots would become unusable.

The restore operation for the After-JNL CDP with snapshot is somewhat different from the restore procedure for the After-JNL CDP. The main difference is that during the restore procedure, the JNL manager 24 operating in accordance with the After-JNL with snapshot model uses the recent snapshot which is latest user specified time or sequence number instead of the baseline volume. The After-JNL with snapshot procedure provides snapshots in place of the baseline volume in order to minimize the amount of JNL data that needs to be applied to the baseline. Therefore, the JNL manager 24 first selects the latest snapshot, which appears before the specified sequence number or the specified time, for which the recovery should be performed. The selected latest snapshot is used in place of the baseline. After the snapshot (baseline) has been selected, the JNL Manager executes the restore operation from Step 201 to Step 206. In the above-described procedure, the JNL manager uses snapshot data instead of the baseline data to create the restore image. In particular, at Step 202, the JNL manager creates a point-in-time (PIT) data from the snapshot of the target LDEV. To restore the volume, the JNL manager applies journal data to the created PIT data.

Case 3: Before-JNL

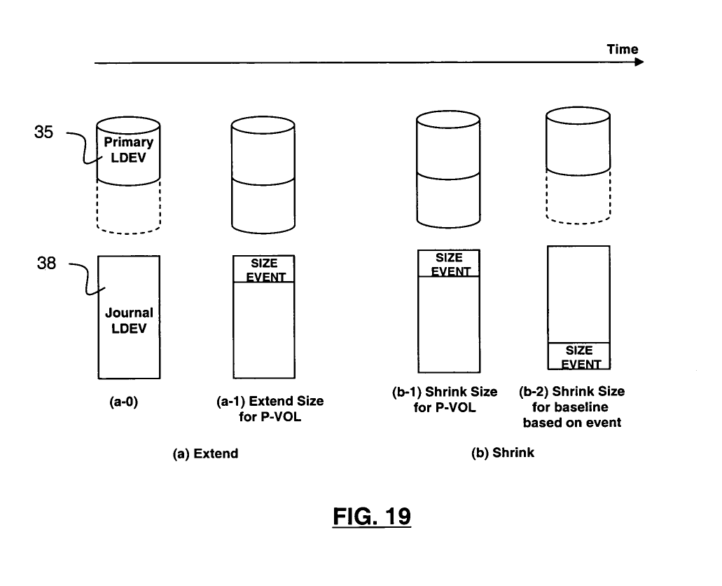

The volume size change operation for the Before-JNL CDP is similar to the one for the After-JNL CDP, which was described hereinabove. The primary differences are in the configuration of the CDP and in the type of the data that is being written to the journal. Because the Before-JNL CDP uses the copy-on-write technology to store the data on the JNL, the primary volume is also a baseline volume. FIG. 19 illustrates the operation of the Before-JNL CDP in relation to the size change operation on the primary volume. FIG. 19(a-0) shows the initial volume configuration. The initial configuration consists of the primary volume 35 and JNL volume 38. FIGS. 19(a-1) and (b-1) show the volume configuration after the completion of the primary volume size change operation. After the administrator issues the size change request via the console 402, the JNL manager 24 executes the volume size change operation. The aforesaid operation involves holding the host's IO operations by the JNL manager 24 (step 181 in FIG. 17(A)), allocating or de-allocating of an LDEV to/from the primary volume 35 (step 182 in FIG. 17(A)), inserting a size marker into the JNL to indicate the capacity by which the primary volume has changed (step 183 in FIG. 17(A)) and, finally, resuming the host's 10 operations (step 184 in FIG. 17(A)). In case of shrinking of the primary volume, the JNL manager 24 verifies that the size of the primary volume is below the capacities specified in any of the inserted size markers of the user(s). This is done because the restore image uses the data in the primary volume.

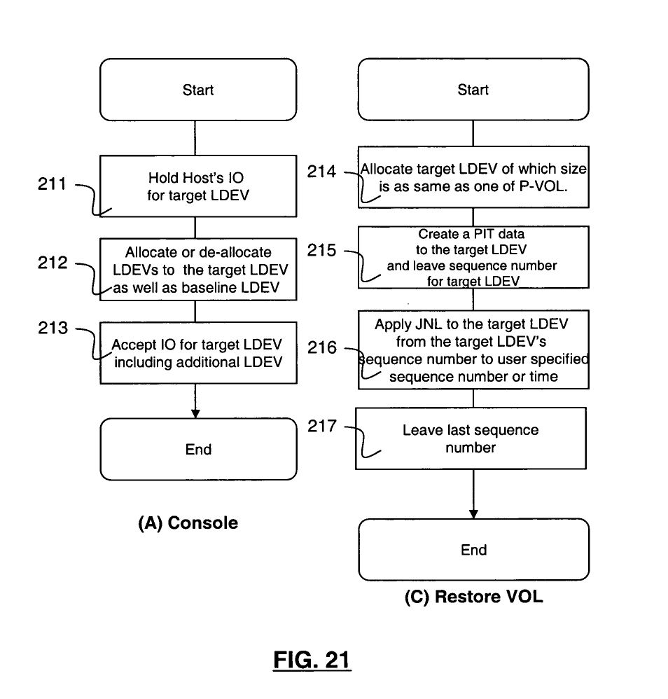

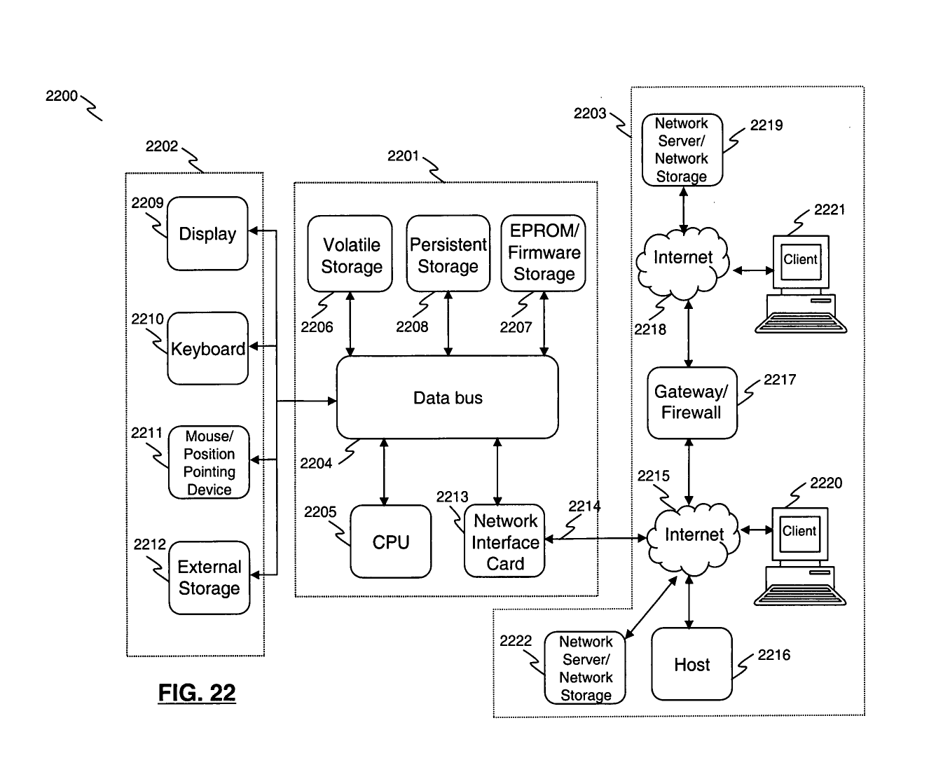

During the restore operation, the JNL manager 24 also relies on the size event to allocate a restore volume. If size events are found in the portion of the JNL from the first journal entry up to the user specified sequence number, the JNL manager 24 selects the latest size event and allocates a restore volume of required size from the LDEV pool. This procedure is shown in FIG. 17(C). The source volume, to which the JNL is applied in order to make the restore image, is the baseline volume in the After-JNL CDP and the primary volume in the Before-JNL CDP. The restore procedure involves the JNL Manager allocating a restore volume from the LDEV pool based on the selection policy described with reference to step 201 of FIG. 17, creating the point-in-time data from the primary volume (step 202 of FIG. 21), checking for past size event(s) in the journal records (step 203 of FIG. 21), allocating LDEVs to target LDEV based on the size event(s) information. The size of the allocated LDEV is the largest size among size events occurring during the user-specified time (see step 204 in FIG. 17(C)). If no size event is detected at step 203, the aforesaid step 204 in FIG. 17(C) is skipped. The restore procedure further involves applying the portion of the Before-JNL data starting from the target LDEV's sequence number and extending until the user specified sequence number or time (step 205 in FIG. 17(C)) and, finally, storing the sequence number corresponding to the last applied journal data (step 206 in FIG. 17(C)).

### Second Embodiment

The second embodiment of the inventive concept illustrates a feature of the inventive concept, wherein the JNL Manager relies on size of the primary volume. The common characteristics of the exemplary implementations described herein is that when the primary volume is shrunk or extended by a command issued from the console 402, all related volumes, such as the baseline volume, are also shrunk and extended accordingly. Moreover, the size of the restore volume must correspond to the size of the primary volume. One of the benefits of the described technique is that the storage system administrators do not need to worry about reconfiguring both the primary volume and the related volumes. This is done automatically by the system.

The physical and logical configuration of the system in accordance with the second embodiment is substantially the same as the described system of the first embodiment, with the exception of the manner of recording of the size event. Therefore, the following description will focus only on the important differences between the two implementations with respect to the After-JNL, After-JNL with snapshot and Before-JNL CDP operating procedures during the primary volume size change and restore operations.

Case 1: After-JNL

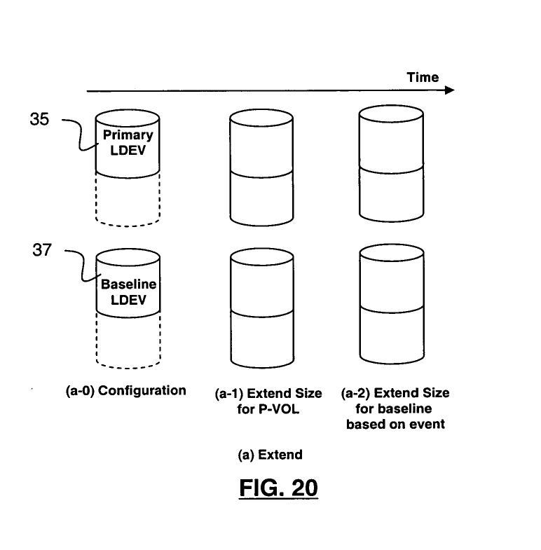

FIG. 20 illustrates the operation of the After-JNL CDP mode during the primary volume size change procedure. The procedure shown in FIG. 20 is characterized by the updated JNL operation (described in steps 111 through 117 in FIG. 10) without utilization of the size event.

Specifically, FIG. 20(a-0) illustrates the initial configuration. The configuration consists of the primary LDEV 35, After-JNL LDEV (not shown) and the baseline LDEV 37. This embodiment of the inventive concept includes means for allocating/de-allocating an LDEV to primary volume. Generally, the described solution may be applied for allocation only because the application data is actually shrunk on de-allocation. Therefore, an application need for this shrink working in case of de-allocation operation.

FIG. 20(a-1) illustrates the operating sequence associated with the changing of the size of the primary volume. After the administrator issues the size change request via the console 402 (FIG. 21(A)), the JNL manager 24 executes the size change operation. The operation involves the JNL manager 24 holding the host's IO operations (step 211 in FIG. 21(A)), allocating or de-allocating of the LDEVs to/from the primary volume and the baseline volume (step 212 in FIG. 21(A)), and, finally, resuming the host's IO operations (step 213 in FIG. 21(A)).

FIG. 21(C) illustrates the operating sequence associated with the restore operation. This embodiment uses the size of the primary volume when the administrator issues the restore request via the console 402. During the restore operation, the console 402 prohibits changing the size of the primary volume. First, the JNL manager 24 allocates a target restore volume having the same size as the primary volume, see step 214 in FIG. 21(C), creates a point-in-time version of the data in the restore volume and writes the sequence number of the restore volume to controller's memory (step 214 in FIG. 21(C)). After that, the JNL manager 24 applies the JNL data to the target LDEV starting from the target LDEV's sequence number and up to the user specified sequence number or time, storing the last sequence number after applying the JNL data.

JNL Manager may also map the target LDEVs through a virtual LU by specifying the LDEV number in column 64 of the table shown in FIG. 5.

Case 2: After-JNL with Snapshot

The After-JNL with snapshot CDP operating in the normal mode executes steps 111 through 117 shown in FIG. 10.

Upon the change of the size of the primary volume, not only the size of baseline volume, but also size of all snapshot volumes must be adjusted. In one embodiment of the invention, the size of the related volumes are adjusted based on the size of the primary volume. On the other hand, the when the size of the primary volume is changed, LDEVs cannot be simply de-allocated from the primary and base volumes, because journal stored in the system may use the data stored in those volumes. If the JNL Manager simply de-allocates one or more LDEVs upon the change of size of the primary and/or baseline volumes, the snapshots which rely on the data stored in the affected volumes will become unusable.

Upon the restore operation, the JNL manager 24 prepares the LDEV of the same size as the size of the primary volume, and then executes the restore operation in the same manner as in the case of the After-JNL with snapshot CDP mode described in connection with the first embodiment.

Case 3: Before-JNL

The Before-JNL CDP operating in the normal mode executes steps 151 through 158 shown in FIG. 14. Upon changing the size of the volumes, the JNL manager 24 may only expand the size of the primary volume. This is done because the Before-JNL CDP relies on the size of the primary LDEV and may use the JNL data located on one or more LDEVs associated with the primary volume. If those LDEV(s) get de-allocated, the associated stored data would become inaccessible jeopardizing the CDP operation.

Upon the restore, the JNL manager 24 uses size of primary volume to prepare the target volume of the same capacity. The restore procedure is similar to After-JNL restore procedure shown in FIG. 21(C), except for the source LDEV to which the journal entries are applied in order to make the point-in-time copy. The procedure involves the JNL manager 24 preparing the restore volume from the LDEV pool, see step 214 of FIG. 21(C), creating the point-in-time data from the primary volume (step 215 of FIG. 21(C)) to restore the volume, and applying the Before-JNL data to restore volume starting with from the target LDEV's sequence number and continuing until the user specified sequence number or time, step 216 of FIG. 21(C). Finally, the sequence number, which corresponds to the last applied journal data is stored, see step 217 of FIG. 21(C).

FIG. 22 is a block diagram that illustrates an embodiment of a computer/server system 2200 upon which an embodiment of the inventive methodology may be implemented. The system 2200 includes a computer/server platform 2201, peripheral devices 2202 and network resources 2203.

The computer platform 2201 may include a data bus 2204 or other communication mechanism for communicating information across and among various parts of the computer platform 2201, and a processor 2205 coupled with bus 2201 for processing information and performing other computational and control tasks. Computer platform 2201 also includes a volatile storage 2206, such as a random access memory (RAM) or other dynamic storage device, coupled to bus 2204 for storing various information as well as instructions to be executed by processor 2205. The volatile storage 2206 also may be used for storing temporary variables or other intermediate information during execution of instructions by processor 2205. Computer platform 2201 may further include a read only memory (ROM or EPROM) 2207 or other static storage device coupled to bus 2204 for storing static information and instructions for processor 2205, such as basic input-output system (BIOS), as well as various system configuration parameters. A persistent storage device 2208, such as a magnetic disk, optical disk, or solid-state flash memory device is provided and coupled to bus 2201 for storing information and instructions.

Computer platform 2201 may be coupled via bus 2204 to a display 2209, such as a cathode ray tube (CRT), plasma display, or a liquid crystal display (LCD), for displaying information to a system administrator or user of the computer platform 2201. An input device 2210, including alphanumeric and other keys, is coupled to bus 2201 for communicating information and command selections to processor 2205. Another type of user input device is cursor control device 2211, such as a mouse, a trackball, or cursor direction keys for communicating direction information and command selections to processor 2204 and for controlling cursor movement on display 2209. This input device typically has two degrees of freedom in two axes, a first axis (e.g., x) and a second axis (e.g., y), that allows the device to specify positions in a plane.

An external storage device 2212 may be connected to the computer platform 2201 via bus 2204 to provide an extra or removable storage capacity for the computer platform 2201. In an embodiment of the computer system 2200, the external removable storage device 2212 may be used to facilitate exchange of data with other computer systems.

The invention is related to the use of computer system 2200 for implementing the techniques described herein. In an embodiment, the inventive system may reside on a machine such as computer platform 2201. According to one embodiment of the invention, the techniques described herein are performed by computer system 2200 in response to processor 2205 executing one or more sequences of one or more instructions contained in the volatile memory 2206. Such instructions may be read into volatile memory 2206 from another computer-readable medium, such as persistent storage device 2208. Execution of the sequences of instructions contained in the volatile memory 2206 causes processor 2205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2208. Volatile media includes dynamic memory, such as volatile storage 2206. Transmission media includes coaxial cables, copper wire and fiber optics, including the wires that comprise data bus 2204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2205 for execution. For example, the instructions may initially be carried on a magnetic disk from a remote computer. Alternatively, a remote computer can load the instructions into its dynamic memory and send the instructions over a telephone line using a modem. A modem local to computer system 2200 can receive the data on the telephone line and use an infra-red transmitter to convert the data to an infra-red signal. An infra-red detector can receive the data carried in the infra-red signal and appropriate circuitry can place the data on the data bus 2204. The bus 2204 carries the data to the volatile storage 2206, from which processor 2205 retrieves and executes the instructions. The instructions received by the volatile memory 2206 may optionally be stored on persistent storage device 2208 either before or after execution by processor 2205. The instructions may also be downloaded into the computer platform 2201 via Internet using a variety of network data communication protocols well known in the art.

The computer platform 2201 also includes a communication interface, such as network interface card 2213 coupled to the data bus 2204. Communication interface 2213 provides a two-way data communication coupling to a network link 2214 that is connected to a local network 2215. For example, communication interface 2213 may be an integrated services digital network (ISDN) card or a modem to provide a data communication connection to a corresponding type of telephone line. As another example, communication interface 2213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2213 sends and receives electrical, electromagnetic or optical signals that carry digital data streams representing various types of information.

Network link 2213 typically provides data communication through one or more networks to other network resources. For example, network link 2214 may provide a connection through local network 2215 to a host computer 2216, or a network storage/server 2222. Additionally or alternatively, the network link 2213 may connect through gateway/firewall 2217 to the wide-area or global network 2218, such as an Internet. Thus, the computer platform 2201 can access network resources located anywhere on the Internet 2218, such as a remote network storage/server 2219. On the other hand, the computer platform 2201 may also be accessed by clients located anywhere on the local area network 2215 and/or the Internet 2218. The network clients 2220 and 2221 may themselves be implemented based on the computer platform similar to the platform 2201.

Local network 2215 and the Internet 2218 both use electrical, electromagnetic or optical signals that carry digital data streams. The signals through the various networks and the signals on network link 2214 and through communication interface 2213, which carry the digital data to and from computer platform 2201, are exemplary forms of carrier waves transporting the information.

Computer platform 2201 can send messages and receive data, including program code, through the variety of network(s) including Internet 2218 and LAN 2215, network link 2214 and communication interface 2213. In the Internet example, when the system 2201 acts as a network server, it might transmit a requested code or data for an application program running on client(s) 2220 and/or 2221 through Internet 2218, gateway/firewall 2217, local area network 2215 and communication interface 2213. Similarly, it may receive code from other network resources.

The received code may be executed by processor 2205 as it is received, and/or stored in persistent or volatile storage devices 2208 and 2206, respectively, or other non-volatile storage for later execution. In this manner, computer system 2201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A method comprising:
a. receiving a volume size change request for a target volume protected by a continuous data protection system;
b. suspending input-output operations between a host and the target volume;
c. changing the capacity of the target volume;
d. writing a new size event corresponding to the target volume to a cache memory or to a journal, the new size event comprising information on the target volume capacity change; and
e. resuming processing of input-output operations between the host and the target volume.

2. The method of claim 1, wherein the target volume comprises an owner logical device and changing the capacity of the target volume comprises allocating an extension logical device to the owner logical device associated with the target volume.

3. The method of claim 2, wherein the owner logical device is specified by an administrator.

4. The method of claim 1, wherein the new size event is written to a header or to a footer of the journal.

5. The method of claim 1, wherein the target volume comprises an owner logical device and at least one extended logical device and changing the capacity of the target volume comprises de-allocating the at least one extension logical device from the owner logical device associated with the target volume.

6. A method comprising:
a. determining whether a used portion of a journal volume of a continuous data protection system exceeds a high watermark;
b. if the used portion is determined not to have exceeded the high watermark, awaiting a predetermined time interval and repeating (a.);
c. if the used portion is determined to have exceeded the high watermark, checking a portion of the journal volume of the continuous data protection system for a size event;
d. if a size event is found, allocating a free logical device of having a size determined based on the last found size event; and
e. applying data from the journal volume to a baseline volume and writing the resulting data to the allocated logical device.

7. The method of claim 6, wherein checking comprises scanning a portion of the journal volume starting with a journal volume record having a sequence number corresponding to a low watermark and continuing up to a journal volume record having a current sequence number.

8. The method of claim 6, wherein the applying comprises applying data from the journal volume to the baseline volume starting with a journal volume record having a sequence number corresponding to a low watermark and continuing up to a journal volume record corresponding the high watermark.

9. The method of claim 6, further comprising updating a sequence number for the baseline volume and information on the used portion of a journal volume.

10. A method for creating a restore image in a continuous data protection system, the method comprising:
a. allocating a target volume in the continuous data protection system from a pool of available logical devices;
b. creating a point-in-time copy of data in the target volume and storing a journal sequence number corresponding to the created point-in-time copy;
c. determining whether the journal contains a size change event;
d. if the size change event is found, allocating or de-allocating at least one logical storage device to the target volume;
e. applying a portion of the journal data to the target volume; and
f. storing the latest journal sequence number after applying the journal data.

11. The method of claim 10, wherein the logical storage devices are allocated to the target volume from a pool of available logical devices.

12. The method of claim 10, wherein the logical storage devices are allocated to the target volume such that a new size of the target volume equals to a size specified in the size change event.

13. The method of claim 10, wherein the point in time copy is created using a baseline volume of the continuous data protection system and a size of the allocated target volume is the same as a size of the baseline volume.

14. The method of claim 10, wherein the applied portion of the journal data starts from a journal sequence number corresponding to the point in time copy and continues to the user specified journal sequence number.

15. The method of claim 14, wherein the specified journal sequence number is determined based on a time specified by a user and wherein the specified journal sequence number corresponds to the user specified time.

16. A method comprising:
a. receiving a volume size change request for a target volume protected by a continuous data protection system;
b. suspending input-output operations between a host and the target volume;
c. changing the capacity of the target volume and a baseline volume of the continuous data protection system; and
d. resuming processing of input-output operations between the host and the target volume.

17. The method of claim 16, wherein the target volume comprises an owner logical device and changing the capacity of the target volume comprises allocating an extension logical device to the owner logical device associated with the target volume.

18. The method of claim 17, wherein resuming processing comprises processing of input-output operations associated with the extension logical device.

19. The method of claim 16, wherein the target volume comprises an owner logical device and at least one extended logical device and changing the capacity of the target volume comprises de-allocating the at least one extension logical device from the owner logical device associated with the target volume.

20. The method of claim 16, wherein the baseline volume comprises an owner logical device and changing the capacity of the baseline volume comprises allocating an extension logical device to the owner logical device associated with the baseline volume.

21. The method of claim 16, wherein the baseline volume comprises an owner logical device and at least one extended logical device and changing the capacity of the baseline volume comprises de-allocating the at least one extension logical device from the owner logical device associated with the baseline volume.

22. A method comprising:
a. allocating a restore volume from a pool of logical devices;
b. creating a point in time copy of data in the primary volume and writing the created copy to the allocated restore volume;
c. applying journal data to the allocated restore volume, the applied journal data starting from a first sequence number corresponding to the created point in time copy and continuing until a second sequence number specified by a user; and
d. storing a third sequence number corresponding to the last applied journal data.

23. A computerized system for continuous data protection, the system comprising:
a. a target volume;
b. a journal volume;
c. a console operable to receive a volume size change request for a target volume;
d. a controller operable to:
i. suspend, in response to the received size change request, input-output operations between a host and the target volume,
ii. change the capacity of the target volume;
iii. write a new size event corresponding to the target volume to a cache memory or to a journal, the new size event comprising information on the target volume capacity change; and
iv. resume processing of input-output operations between the host and the target volume.

24. A computerized system for continuous data protection, the system comprising:
a. a primary volume storing user application data;
b. a baseline volume storing a point in time copy of data in the primary volume;
c. a journal volume storing primary volume data change information;
d. a storage device storing a high watermark value and a low
watermark value; and
e. a journal manager operable to:
i. determine whether a used portion of the journal volume exceeds the high watermark value;
ii. if the used portion is determined not to have exceeded the high watermark value, await a predetermined time interval and repeat (a.);
iii. if the used portion is determined to have exceeded the high watermark value, check a portion of the journal volume for a size event;
iv. if a size event is found, allocate a free logical device having a size determined based on the last found size event; and
v. apply data from the journal volume to the baseline volume and write the resulting data to the allocated logical device.

25. A computerized system for continuous data protection, the system comprising:
a. a pool of available logical devices;
b. a journal volume;
c. a controller operable to:
i. allocate a target volume from the pool of available logical devices;
ii. create a point-in-time copy of data in the target volume and store a journal sequence number corresponding to the created point-in-time copy;
iii. determine whether the journal volume contains a size change event;
iv. if the size change event is found, allocate or de-allocate at least one logical storage device to the target volume;
v. apply a portion of the journal data to the target volume; and
vi. store the latest journal sequence number after applying the journal data.

26. A computerized system for continuous data protection, the system comprising:
a. a target volume protected by a continuous data protection system;
b. a baseline volume storing a point in time copy of data in the target volume;
c. a console operable to receive a volume size change request for the target volume; and
d. a controller operable to:
i. suspend input-output operations between a host and the target volume;
ii. change the capacity of the target volume and the baseline volume; and
iii. resume processing of input-output operations between the host and the target volume.

27. A computerized system for continuous data protection, the system comprising:
a. a pool of available logical devices;
b. a primary volume;
c. a journal volume; and
d. a controller operable to:
i. allocate a restore volume from the pool of available logical devices;
ii. create a point in time copy of data in the primary volume and write the created point in time copy to the allocated restore volume;
iii. apply data stored in the journal volume to the allocated restore volume, the applied journal data starting from a first sequence number corresponding to the created point in time copy and continuing until a second sequence number specified by a user; and
iv. store a third sequence number corresponding to the last applied journal data.

28. The computerized system of claim 27, further comprising a console operable to receive information on the second sequence number from a user.
